(19) United States
(12) Patent Application Publication
(10) Pub. No.: US 2003/0226425 A1
(43) Pub. Date: Dec. 11, 2003

(54) Helping-hand vial grip and dispenser

(76) Inventor: Georges Gotlib, New York, NY (US)

Correspondence Address: Schwegman, Lundberg, Woessner & Kluth, P.A., P.O. Box 2938, Minneapolis, MN, 55402, US

(21) Appl. No.: 10/401,511

(22) Filed: Mar. 27, 2003

Related U.S. Application Data
(60) Provisional application No. 60/368,082, filed on Mar. 27, 2002.

(51) Int. Cl. B67B 7/00

(52) U.S. Cl. 81/3.25

(57) ABSTRACT

The invention provides a holding device for cylindrical objects such as containers, bottles, jars, and vials. The device has a platform having at least one notch therein; a first jaw disposed along a first portion of the notch, the first jaw including a textured surface; a jaw guide disposed along a second portion of the notch; a second jaw rotatably disposed within the notch, the second jaw including a textured surface, and the second jaw movable along the jaw guide to an open position allowing a container to be received between the first jaw and the second jaw; and a member coupled with the second jaw to force the second jaw toward the first jaw with sufficient force to stably hold the container during opening of the container.

This application claims the benefit of priority under 35 U.S.C. 119 (e) to U.S. Provisional Patent Application Serial No. 60/368,082, filed Mar. 27, 2002, which is incorporated herein by reference.

### FIELD OF THE INVENTION

The invention provides a device that allows the user to easily hold, open, and withdraw contents from various containers including but not limited to, vials, bottles and jars. Using this device, such containers can be manipulated with one hand.

### BACKGROUND OF THE INVENTION

In hospitals and doctors' and dentists' offices, countless inpatient and outpatient medical procedures are performed daily that require the use of a local anesthetic (e.g. lidocaine) for patient comfort. Such an anesthetic must be administered to the patient in a sterile manner. Similarly, during surgery, the surgeon or anesthesiologist must often administer therapeutic agents and medical solutions in order to properly treat the patient and perform the operation. Such administration must be performed in a sterile manner. The surgeon must maintain his or her surgical gloves in a sterile manner to avoid contaminating the surgical incision. In addition, the patient is also maintained under sterile conditions, often with the use of antiseptic solutions and sterile drapes at the site of the surgical field.

Sterile vials containing therapeutic agents or medical solutions are sometimes included in kits, ready for handling by a sterile proceduralist. However, many vials are not maintained in a sterile manner, and can be found on the supply shelves of hospitals or doctors' offices. For example, the anticoagulants heparin and EDTA are stored in glass vials and are used for the collection of bone marrow material during a bone marrow biopsy in order to prevent clotting of the specimen.

Non-sterile vials must be handled by assistants (e.g. nurses or technicians) so that the hands of the sterile proceduralist do not breach sterility. For example, the assistant may hold a vial of lidocaine upside down so the proceduralist can withdraw the sterile solution with a syringe without having to touch the non-sterile vial. Even in cases in which sterile vials are provided in kits, the proceduralist regard the vials as non-sterile just to be careful. Moreover, the volume in such vials is small and quickly spent, often requiring additional “off the shelf” non-sterile vials to be used.

Nurses and other attendants are therefore often required to help sterilize, retrieve, open, or simply hold vials and bottles containing the therapeutic agents and medical solutions needed by health care professionals. Assistants could be attending to other patients, or help in a more meaningful way with the procedure if they were not needed for retrieving, opening, or holding such bottles or vials. Hence, a device is needed that can hold a bottle or vial, and that can be used to open the bottle or vial in a sterile manner.

Lids mounted by threading onto jars or bottles are difficult to loosen by hand. Some hand-held and mounted devices have been developed for alleviating the difficulty for such tasks. The hand-held devices commonly have an adjustable gripping means that can grasp the lid of the jar firmly, and a handle that the user may then turn relative to the jar to loosen or tighten the lid. Such hand-held devices are usually awkward to operate because the user must hold the jar or bottle firmly with one hand while turning the handle of the device with the other hand. Such operation can be frustrating when the jar or bottle cannot be held firmly because the hand holding the jar or bottle is usually weaker. Many users may also not have the dexterity or strength to perform the task.

The mounted openers are more convenient and easier to operate because the user may grip the jar or bottle firmly with both hands and turn it relative to the mounted opener. However, most mounted devices are designed only for opening jar or bottle lids, and cannot be used for opening vials. Many therapeutic agents, such as lidocaine, are commonly provided in small-volume glass or plastic vials. Glass vials usually have a tapered top that is snapped off, allowing therapeutic agents or medical solutions to be withdrawn using a syringe. Plastic vials usually have a plastic diaphragm through which a needle is inserted to withdraw the therapeutic agent or medical solution. In order to withdraw the solution through a syringe, the vials are held upside down. In the case of glass vials where the tapered end has been snapped off, capillary action keeps the liquid from leaking out. A device that facilitates opening of such small vials is needed to streamline surgical procedures and to relieve nurses of the task of manipulating and opening vials.

U.S. Des. Pat. No. 258,192 to Robert W. Maloney shows a jar opener with a V-shaped wedge that may be mounted under the kitchen cupboard. Two serrated blades are mounted one on each side of the wedge with the teeth on one blade skewed in one direction and the teeth of the other blade skewed in the opposite direction. When the lid of the jar is urged against the blades, the teeth of the two blades, skewed in the opposite directions, would cooperate to grip the lid firmly by biting into the lid side wall while the jar is being turned so as to open the lid. However, the blades are straight and mounted in a fixed manner so that the device cannot accommodate a wide range of jars, bottles, and especially small vials. Moreover, the top of the device is so close to the blades that only flat-lidded bottles and jars can be easily opened. U.S. Pat. No. 4,262,560 by Charles C. Hoffberger shows an opener that suffers from similar problems.

U.S. Pat. No. 5,943,920 to McGivern et al. discloses ajar and bottle lid opener with a V-shaped body having two elongated legs extending divergently from a vortex. A flexible belt with a high coefficient of friction (e.g., rubber) is mounted along the inside of one of the legs. An adjusting button is used to tighten or loosen the flexible belt. The lid of a jar can be urged up against the wedge. The wedge with the flexible belt grips the lid while the jar is turned clockwise. According to McGivern et al., this device can be used with either one hand or both hands. However, the device described by McGivern et al. relies upon the flexible belt to grip the lid of the jar and does not have a lever-actuated or spring mechanism for drawing the jaws together.

Simpler, more effective holding and opening devices are therefore needed, particularly for opening small vials and prescription medicine containers.

### SUMMARY OF THE INVENTION

The invention provides a device that enables users to perform certain manual tasks with one hand or no hands, which normally require the use of two hands. In particular, the invention facilitates the one-handed opening of vials or bottles and withdrawal of liquid solutions from them. The holder/opener is a mechanical device that includes:

a) a platform that may be stably fixed to a support structure, such as a wall;

b) a set of two opposing jaws for gripping a cylindrical object; and

c) a mechanism for drawing the jaws together.

The jaws are sufficiently resilient to open when a cylindrical object, such as a vial or bottle, is pushed between them and is pulled out of them. However, the mechanism holding the jaws together is of sufficient strength, and the interior rims of the jaws grasp the cylindrical object with sufficient friction, to stably hold the cylindrical object during opening or withdrawal of a solution.

In some embodiments, the device has a platform having at least one notch therein; a first jaw disposed along a first portion of the notch, the first jaw including a textured surface; a jaw guide disposed along a second portion of the notch; a second jaw rotatably disposed within the notch, the second jaw including a textured surface, wherein the second jaw is movable along the jaw guide to an open position allowing a container to be received between the first jaw and the second jaw; and a member coupled with the second jaw to force the second jaw toward the first jaw with sufficient force to stably hold the container during opening of the container.

In other embodiments, the device comprises a platform having a notch and a jaw guide, a first jaw and a second jaw for gripping a container, and a lever-actuated or spring mechanism for drawing the first and second jaws together; wherein the first jaw comprises a textured surface lining one edge of the notch within the platform; wherein the second jaw comprises an arm with a textured surface and wherein the second jaw is rotated by the lever-actuated or spring mechanism along the jaw guide to force the first and second jaws together with sufficient force to stably hold the container during opening but wherein the lever-actuated or spring mechanism is sufficiently resilient to open the jaws when the container is pulled out of them.

Also provided are methods for obtaining liquids from a container comprising: inserting a container containing liquids into a device; and withdrawing liquids from the container. Any of the devices described herein can be utilized in such methods. In some embodiments, the liquids are withdrawn from the container in a sterile manner.

### DESCRIPTION OF THE DRAWINGS

FIG. 1 illustrates a top perspective of a holding or opening device in accordance with one embodiment.

FIG. 2 illustrates a bottom perspective of a holding or opening device in accordance with one embodiment.

FIG. 3 illustrates a top perspective of a holding or opening device in accordance with another embodiment.

FIG. 4 illustrates a bottom perspective of a holding or opening device in accordance with another embodiment.

FIG. 5 provides a perspective view of the jaw mechanism.

FIG. 6 illustrates a bottom perspective of a holding or opening device in accordance with another embodiment.

FIG. 7 illustrates a top perspective of a holding or opening device in accordance with another embodiment.

FIG. 8 illustrates an exploded view of a holding or opening device in accordance with one embodiment.

### DETAILED DESCRIPTION OF THE INVENTION

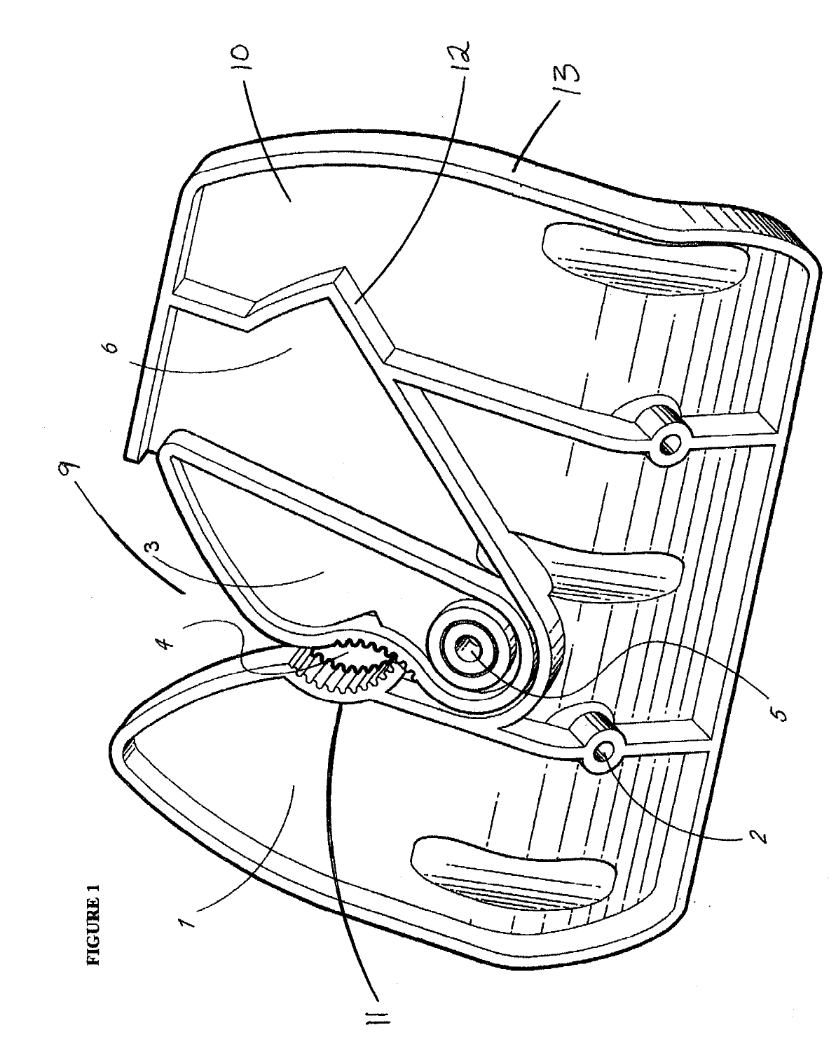

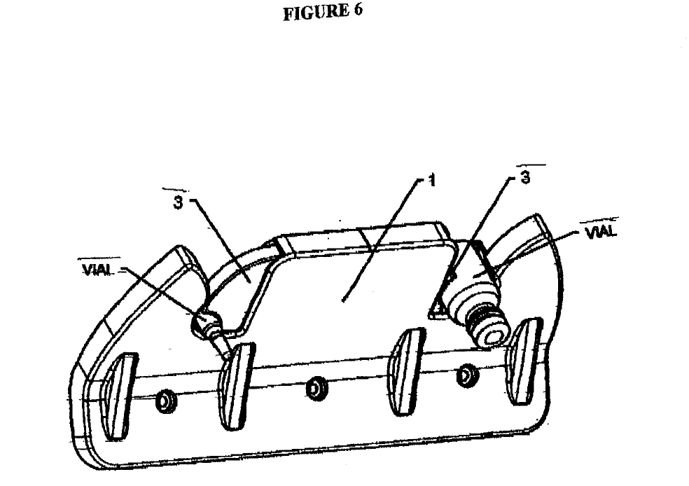

A mechanical device 10 is provided for holding objects and/or for opening containers such as vials, bottles, and jars. One example is shown in FIG. 1. The device 10 has a platform 1 with a notch 9 and a jaw guide 6. Two opposing jaws, a first jaw 11 and a second jaw 3, are provided for gripping the container. A member 5 provides a force that draws the first 11 and second jaws together. Both jaws can have a textured surface 4 along the surface used for gripping the container (FIG. 6). The first jaw 11 is part of the notch 9 within the platform 1. The second jaw 3 is an arm that is rotated by the member 5 along the jaw guide 6 of the platform 1 to force the first 11 and second jaws together with sufficient force to stably hold the container or vial during opening or withdrawal of a solution. However, the member 5 is sufficiently resilient to open the jaws when the vial is pulled out of them. The platform 1 of the device 10 can be stably fixed to a support structure such as a wall, a support column, or any available frame.

The edges of the jaws (3, 11) that face each other are shaped to allow the insertion of cylindrical or oblong objects such as vials or other containers (see, for example, FIG. 6). For example, the edge of the jaws (3, 11) that holds the container can have an arcuate or concave shape. A textured surface 4 can line the surface of the jaws (3, 11) that hold cylindrical or oblong objects such as vials or containers. Such a textured surface 4 can include a roughened surface, a knurled surface, teeth and the like.

The vials or containers that are used with the device 10 can have a variety of diameters. For example, the diameter of the cylindrical or oblong objects can range from about 5 millimeters to about 100 millimeters, preferably about 5 millimeters to about 40 millimeters.

As mentioned above, the device 10 has a notched platform 1. A first jaw 11 is set within and forms a part of the notch 9 of the platform 1. The first jaw 11 does not move when the device 10 is used for grasping and opening a container. The first jaw 11 can be curved to fit against a curved container, and it can have a textured surface 4 to grasp the container. A second jaw 3 can be rotated by a member 5 along the jaw guide 6 of the platform 1 to press the second jaw 3 against the first jaw 11 with sufficient force to stably hold the container during opening. Like the first jaw 11, the second jaw 3 can be curved to fit against a curved container and can have a textured surface 4.

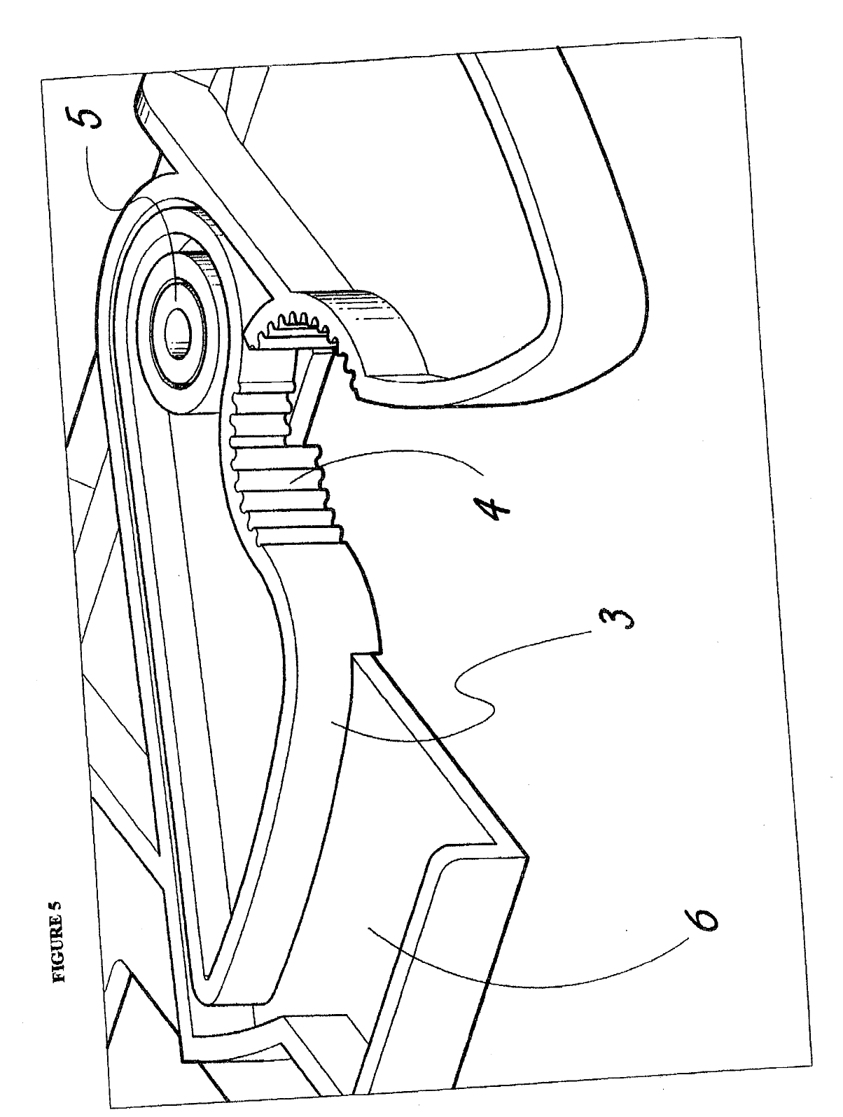

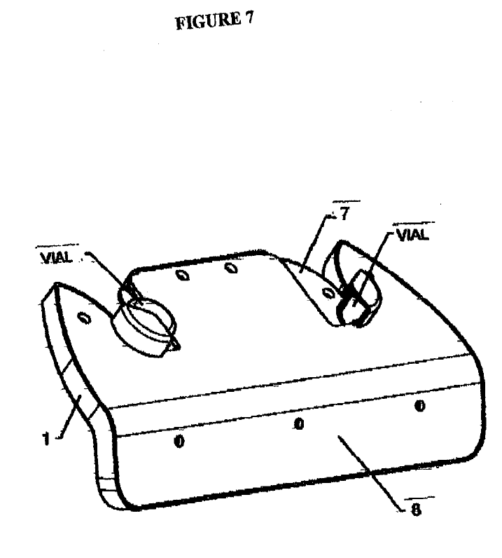

The member 5 is a mechanism for forcing the rotatable second jaw against the first jaw 11 (see, e.g., FIG. 5). The member 5 is attached to the platform 1 within the notch 9. Such a member 5 can, for example, be a lever-actuated mechanism or a spring mechanism. The member 5 can also be a tension spring comprising a tightly coiled wire where one end of the wire is attached to the second jaw 3 and the other is fixed against the platform 1. When not in use, the member 5 exerts a force that causes the first 11 and second 3 jaws to press together. However, the user may push a container against the opening of the notch 9 to force the second jaw 3 to rotate within the jaw guide 6, thereby opening the first 11 and second 3 jaws to an extent needed to place the container within these jaws. The first 11 and second 3 jaws then extend divergently from a vertex formed by the member 5 and the force of the member 5 causes the first 11 and second 3 jaws to close around the container when the container is pushed against the textured surface 4. The force provided by the member 5 is sufficient to hold the container securely during an opening or withdrawal procedure. The curved and textured surfaces 4 of the first 11 and second 3 jaws help to stabilize and hold the container (FIG. 6). Moreover, the curved surfaces, and the width and the textured surface 4 of the first 11 and second 3 jaws also help to prevent twisting of the container during the opening or withdrawal procedure. In some embodiments, a jaw cover 7 (FIG. 7) also helps to hold the vial by providing additional vertical stability to the container.

The textured surface 4 can be coated with natural or synthetic rubber, plastic, or any convenient coating material that has gripping and/or compression properties selected by one of skill in the art.

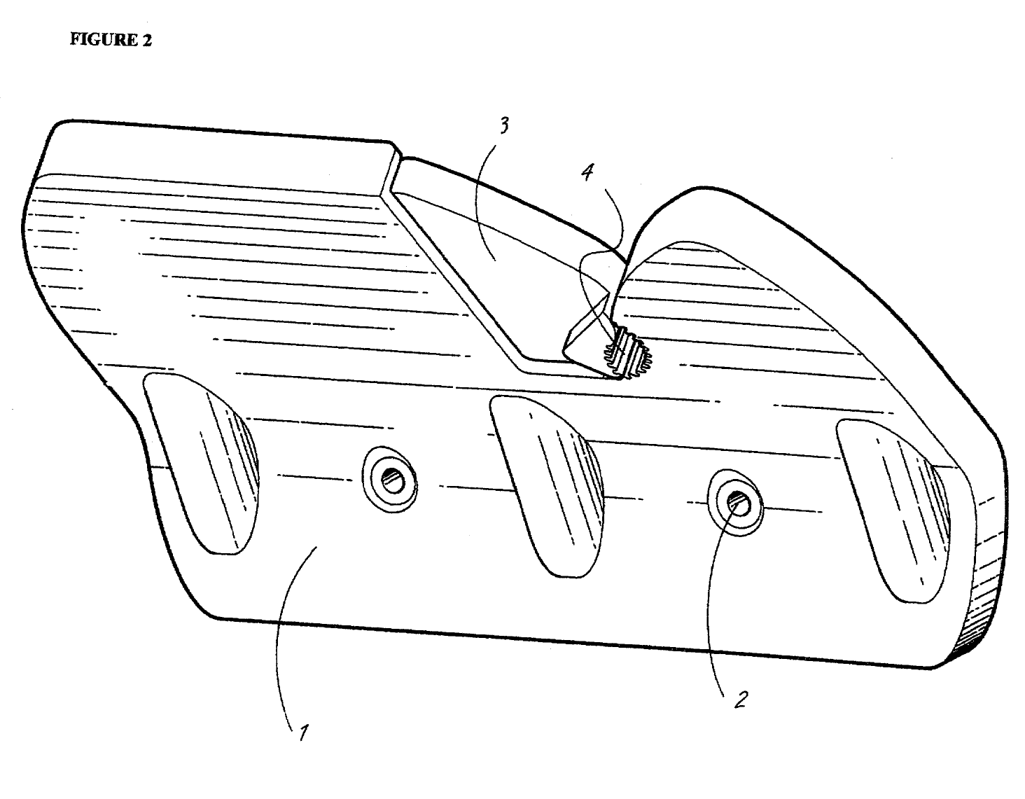

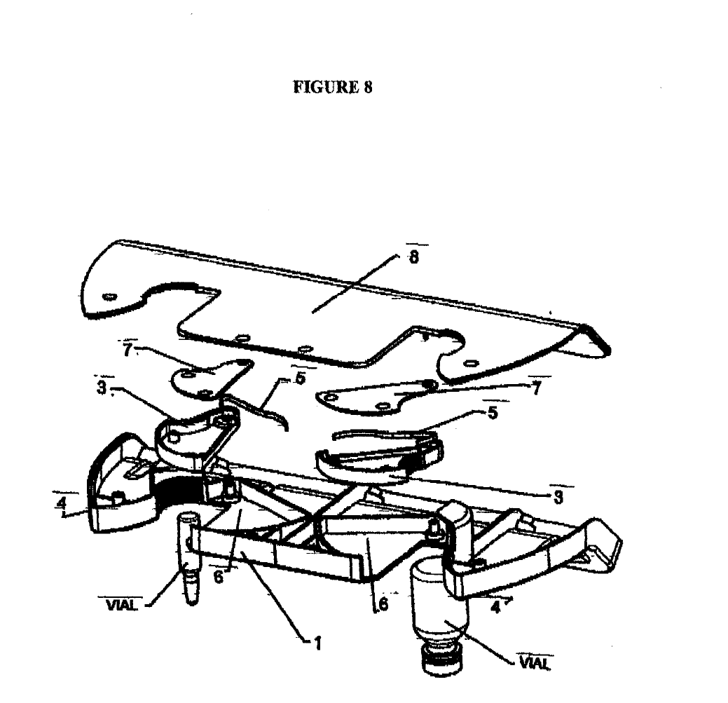

The platform 1 can have any convenient shape, for example, generally a rectangular, square, triangular, oval or circular shape. The area of the platform 1 having the notch 9, the jaw guide 6, and the member 5 has a substantially flat lower surface. However, one edge of the platform 1 can be bent at a convenient angle to allow the platform 1 to be fixed to a solid surface (see FIG. 2), for example, through mounting holes 2. The platform 1 and the bent edge may be an integral unit; alternatively, the platform 1 and the bent edge can be formed separately and then joined together. The bent edge may also be provided as a separate bracket to which the platform 1 can be attached. Mounting holes 2 can be present within the platform 1 for fixing the platform 1 to the solid surface or a bracket. A two-sided high-strength adhesive can also be used to conveniently and quickly mount the device 10, without the use of any tool, on a wall, cupboard, bookcase or a side of a counter. Mounting holes 2 may also be provided in the bent edge so that the device 10 may be mounted on a solid support by screws. In some embodiments, a base cover 8 is employed (FIG. 8).

Referring to FIG. 5, the jaw guide 6 is a substantially flat surface along which the second jaw 3 can rotate. The jaw guide 6 can have a stop 12 to arrest the second jaw 3 at its fully open position. Such a stop 12 can be a raised projection or lip projecting out of the platform 1. The jaw guide 6 can also have a border to partially or completely define the arc along which the second jaw 3 travels as it is opened and closed. Such a border can be a raised projection or lip that may run contiguously from the stop 12 to the notch 9 on one side of the platform 1 (FIG. 1). The border may strengthen the platform 1, may help stabilize the second jaw 3, or may be simply decorative.

Referring again to FIG. 1, a lip 13 exists in some embodiments at the periphery of the platform 1. Such a lip 13 extends perpendicularly from the top surface of the platform 1. In another embodiment, the lip 13 is present on both the top and bottom of the platform 1. In yet another embodiment, the lip 13 is present only on the top or only on the bottom of the platform 1. A lip 13 on the top transforms the platform 1 into a tray that can readily hold objects like the lid of a container, tip of a vial or a syringe, or other instrument needed by the proceduralist. The lip 13 can also strengthen the platform 1, and/or stabilize and strengthen the angle of the bent edge that is used for attachment of the device 10 to a solid support. In another embodiment, the lip 13 does not extend into the bent edge, because a bent edge that forms a flat surface may be easier to attach to a solid support.

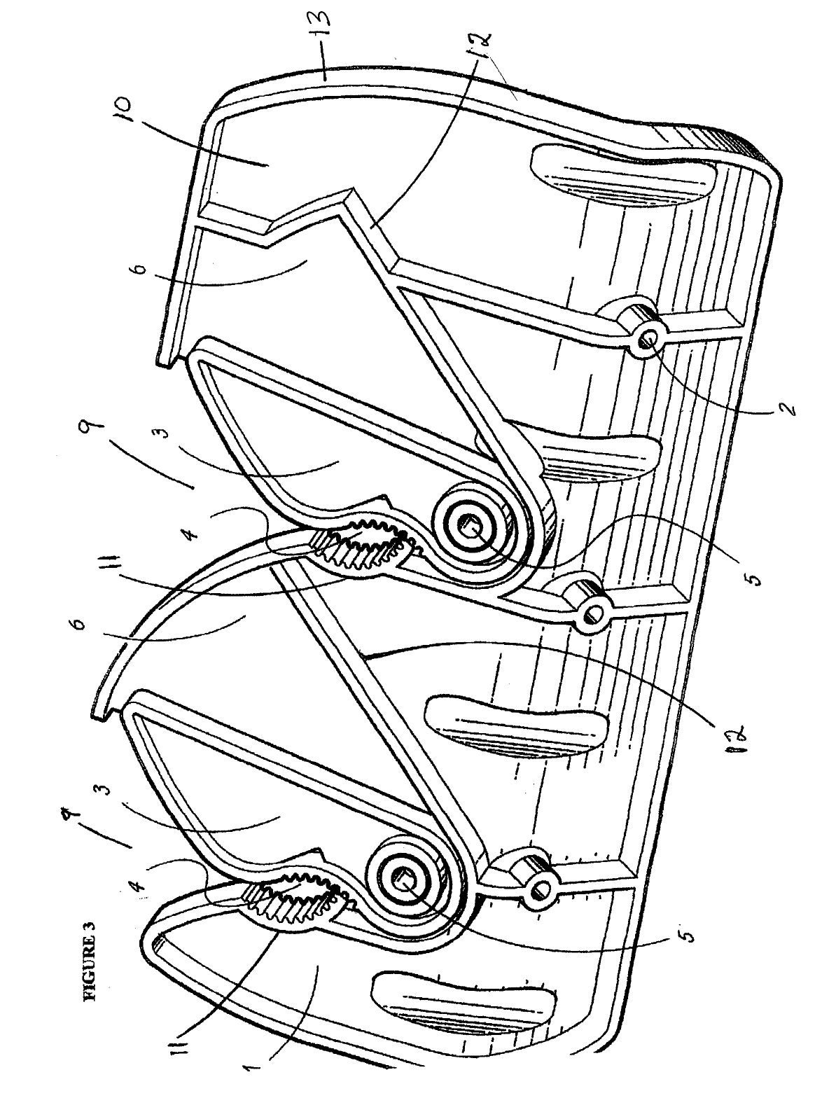

The notch 9 is generally V-shaped, although any shape that can accommodate the first jaw 11 and provide an opening into which the container can be placed is contemplated by the invention. A lip 13 may be present within the notch 9 so long as it does not interfere with the arcuate movement of the second jaw 3 (FIG. 1). In some embodiments, a lip 13 exists only on the side of the notch 9 that has the first jaw 11 (see, e.g. FIGS. 1 and 3). In this position, the lip 13 may increase the width, strength, and stability of the first jaw 11.

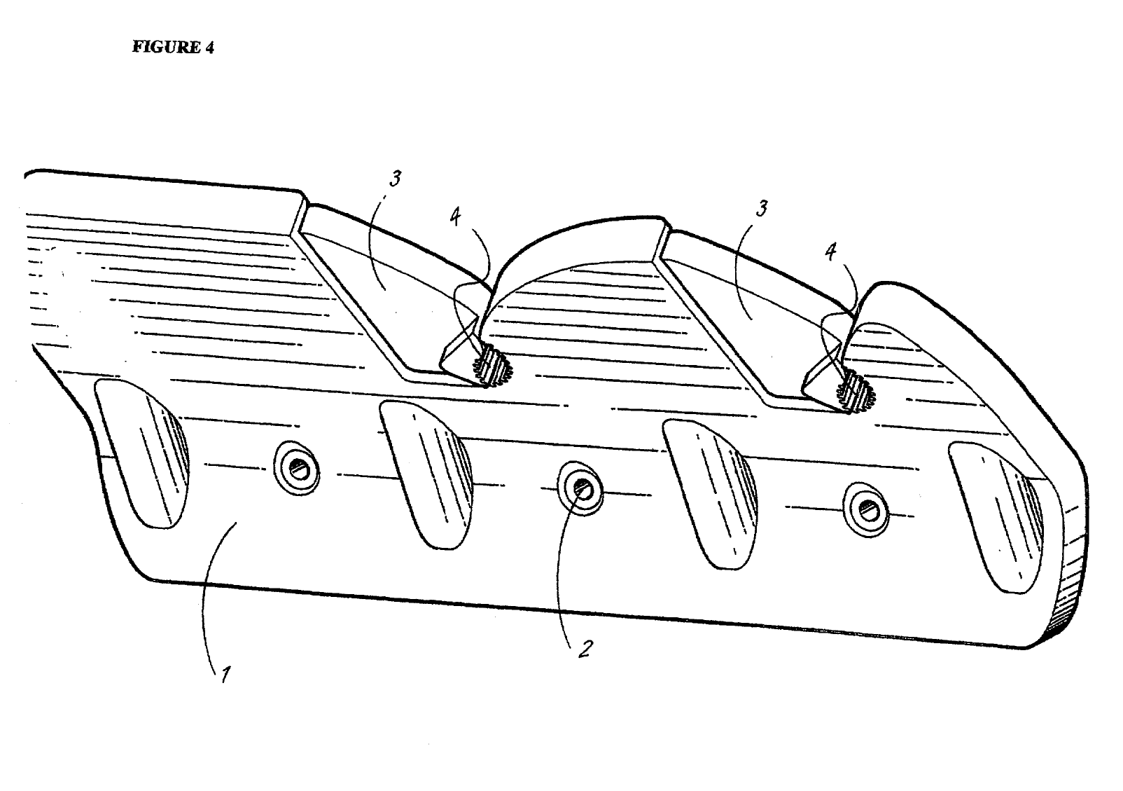

As illustrated in FIGS. 3, 4 6, 7 and 8, more than one holding unit can be present within the device 10. Such a multi-unit device can have a single platform 1 but more than one notch 9, where each notch comprises a complete holding unit. For example, in some embodiments the device 10 comprises a platform 1 having two to four notches 9 therein. Each notch 9 in the platform 1 has a first jaw 11 disposed along a first portion of the notch 9. Each notch 9 in the platform 1 also has a jaw guide 6 disposed along a second portion of the notch 9. A second jaw 3 is rotatably disposed within each notch 9 in the platform 1 of such a multi-unit device, where the second jaw 3 is movable along the jaw guide 6 to an open position allowing a container to be received between the first jaw 11 and the second jaw 3. A member 5 is coupled with the second jaw 3 within each notch 9, to force the second jaw 3 toward the first jaw 11 with sufficient force to stably hold the container during opening of the container. The first jaw 11 and the second jaw 3 within each notch 9 can have a textured surface 4. Hence, using such a multi-unit device, several different containers can be simultaneously held at once, then individually opened and used as needed.

The device 10 can be manufactured in various sizes to accommodate a variety of cylindrical objects, containers, jars, and vials of different sizes. The device 10 may also be manufactured in a variety of configurations so that it can be permanently attached to a solid support, or so that it can be readily transportable as the need arises.

The device 10 can be made from any convenient material available to one of skill in the art. However, plastic and/or metal alloys are preferred and may be cost effective materials for this device 10.

The device 10 can securely hold vials upright or in an inverted position (see, e.g., FIGS. 6-8). When held in an inverted position, medical solutions and therapeutic agents can be withdrawn through a syringe.

The device 10 can also be used for a wide variety of tasks in many different situations. In addition to providing many benefits for the medical proceduralist, this device 10 is useful in helping individuals who have temporarily or permanently lost the use of one hand. The device 10 of the invention may also act as a mechanical “third hand” to facilitate certain activities by non-disabled individuals.

The use of the device 10 can be applied to fields of activity including medical, dental, and surgical procedures, home health care, personal care, hygiene and grooming, eating and cooking, household chores and repairs, office work, sports, games, leisure activities, and travel.

The device 10 may be useful in a variety of medical and dental procedures, including lumbar puncture, suturing of lacerations, bone marrow biopsy, skin biopsy, insertion of central venous catheters, radial artery cannulation for blood gas determination, diagnostic and therapeutic thoracentesis, paracentesis and arthrocentesis, dental procedures such as tooth extraction, root canal, and the like.

The following examples further illustrate some possible applications of the invention, but the invention is not limited to the applications specifically provided herein.

### EXAMPLE 1

### Medical Procedures

“Hands-Free” use of Non-Sterile Vials

Prior to becoming sterile for a procedure, the health care professional could easily place non-sterile vials in the jaws (3, 11) of the device 10. During the procedure, a local anesthetic such as lidocaine could be withdrawn from the secured vial(s) (FIG. 7) without compromising sterility. Otherwise, the proceduralist would require an assistant to hold the non-sterile vials, or would have to abandon sterility by handling the non-sterile vials himself. As illustrated in FIGS. 3, 4 6, 7 and 8, more than one holding unit can be present in the device 10. Hence, several different containers can be simultaneously held at once, then individually opened and used as needed.

Labor-Saving Device 10

A device 10 that securely holds non-sterile vials would obviate the need for an assistant to hold the vials. Oftentimes, nurses are asked to perform this function, removing them from other critical patient care duties. In addition, the proceduralist must wait for an assistant to become available, which often wastes precious time that could be directed toward treating the patient or other patients that require attention. All of the containers from which materials must be withdrawn during a procedure can be placed in a multi-unit device, for example, as shown in any of FIGS. 3, 4 6, 7 and 8. Each container can then be opened and its contents can be withdrawn as needed, thereby streamlining medical procedures, particularly those requiring sterile conditions, and eliminating the need for assistance from other medical personnel.

Increased Safety

When an assistant holds a vial in the inverted position for withdrawal of a medical solution by a needle, the potential for a needle stick exists. In cases in which a proceduralist reaches for a sterile vial in a kit with exposed sharp objects (e.g. needles, scalpels, etc), a similar potential for a needle stick exists. In both circumstances, transmission of infectious disease(s) is a real concern because of potential contamination of needle tips by patient blood or bodily fluids. However, when containers are held by the device 10, for example, as shown in FIGS. 6-8, the possibility of such puncture wounds is eliminated.

The device 10 also increases safety by allowing direct access to, and visualization of, a firmly-held labeled vial that contains a therapeutic agent or medical solution. When the device 10 is positioned in close proximity to the health professional's working environment, this eliminates the need for transferring the solution to a second container or medium. Subsequent use of therapeutic agents or medical solutions from unlabeled storage media can result in accidental use of the wrong solution, and serious morbidity or mortality for patients.

Flexibility

The device 10 is capable of holding glass or plastic vials of varying sizes. For example, vials containing from 1 cc to 30 cc of medical solution can be securely held by the device 10, allowing the proceduralist to access therapeutic agents or medical solutions of suitable quantity for the procedure being performed.

### EXAMPLE 2

### Disabled Individuals

The device 10 of the invention can be used by people who have temporarily or permanently lost the use of one hand. Although some devices exist that claim to assist one-handed individuals, these devices generally have limited versatility and can only assist with one or two specific tasks. The device 10 of the invention can help hold and secure certain objects in a desired position for one-handed individuals, thereby freeing the hand to perform an active role.

The device 10 is used either in a fixed, or movable mode. The device 10 facilitates two-handed operations in everyday activities such as personal care (bathing and grooming), cooking and eating (cutting and slicing), removing container closures (prescription pills, bottles, jars, or rolls of photographic film containers), as well as other activities.

### EXAMPLE 3

### Mobile “Third Hand”

The device 10 of the invention can be designed to accommodate interchangeable gripping jaws 3 and 11, so that the device 10 is able to accept and hold objects of larger diameters and configurations than vials, bottles of prescription medicines, and the like. The device 10 can be affixed in a permanent position or mounted to an ambulatory frame, to help the user secure objects in the desired position, therefore freeing both hands to perform operations more efficiently and quickly, in a number of activities as listed herein.

All publications and patents are incorporated by reference herein, as though individually incorporated by reference. The invention is not limited to the exact details shown and described, for it should be understood that many variations and modifications may be made while remaining within the spirit and scope of the invention.

What is claimed:

1. A device comprising:
a platform having a notch therein;
a first jaw disposed along a first portion of the notch, the first jaw including a textured surface;
a jaw guide disposed along a second portion of the notch;
a second jaw rotatably disposed within the notch, the second jaw including a textured surface, and the second jaw movable along the jaw guide to an open position allowing a container to be received between the first jaw and the second jaw;
a member coupled with the second jaw to force the second jaw toward the first jaw with sufficient force to stably hold the container during opening of the container.

2. A device for facilitating opening and withdrawal of solutions from a container, comprising a platform having a notch and a jaw guide, a first jaw and a second jaw for gripping a container, and a lever-actuated or spring mechanism for drawing the first and second jaws together;
wherein the first jaw comprises a textured surface lining one edge of the notch within the platform;
wherein the second jaw comprises an arm with a textured surface and wherein the second jaw is rotated by the lever-actuated or spring mechanism along the jaw guide to force the first and second jaws together with sufficient force to stably hold the container during opening but wherein the lever-actuated or spring mechanism is sufficiently resilient to open the jaws when the container is pulled out of them.

3. The device of claim 1, wherein the member is a tension spring.

4. The device of claim 2, wherein the lever-actuated or spring mechanism is a tension spring.

5. The device of claim 1 or 2, wherein the device further comprises a jaw cover.

6. The device of claim 1 or 2, wherein the container is a jar, vial, bottle, or prescription medicine container.

7. The device of claim 1 or 2, wherein the platform is bent to facilitate attachment to a support structure.

8. A device comprising a platform having two to four notches therein, each notch comprising:
a first jaw disposed along a first portion of the notch, the first jaw including a textured surface;
a jaw guide disposed along a second portion of the notch;
a second jaw rotatably disposed within the notch, the second jaw including a textured surface, and the second jaw movable along the jaw guide to an open position allowing a container to be received between the first jaw and the second jaw;
a member coupled with the second jaw to force the second jaw toward the first jaw with sufficient force to stably hold the container during opening of the container.

9. The device of claim 8, wherein the member is a lever-actuated or spring mechanism.

10. The device of claim 8 wherein the member is a tension spring.

11. The device of claim 8, wherein the device further comprises a jaw cover.

12. The device of claim 8, wherein the container is a jar, vial, bottle, or prescription medicine container.

13. The device of claim 8, wherein the platform is bent to facilitate attachment to a support structure.

14. A method for obtaining liquids from a container in a sterile manner, comprising:
inserting a container containing liquids into a device; and
withdrawing liquids from the container in a sterile manner;
wherein the device comprises:
a platform having a notch therein;
a first jaw disposed along a first portion of the notch, the first jaw including a textured surface;
a jaw guide disposed along a second portion of the notch;
a second jaw rotatably disposed within the notch, the second jaw including a textured surface, and the second jaw movable along the jaw guide to an open position allowing a container to be received between the first jaw and the second jaw;
a member coupled with the second jaw to force the second jaw toward the first jaw with sufficient force to stably hold the container during opening of the container.

15. A method for obtaining liquids from a container in a sterile manner, comprising:
inserting a container containing liquids into a device; and
withdrawing liquids from the container in a sterile manner;
wherein the device comprises a platform having a notch and a jaw guide, a first jaw and a second jaw for gripping a vial, and a lever-actuated or spring mechanism for drawing the first and second jaws together;
wherein the first jaw comprises a set of teeth lining one edge of the notch within the platform;
wherein the second jaw comprises an arm with teeth that is rotated by the lever-actuated or spring mechanism along the jaw guide to force the first and second jaws together with sufficient force to stably hold the vial during opening but wherein the lever-actuated or spring mechanism is sufficiently resilient to open the jaws when the vial is pulled out of them; and
wherein the platform can be stably fixed to a support structure.

16. The method of claim 14, wherein the member is a tension spring.

17. The method of claim 15, wherein the lever-actuated or spring mechanism is a tension spring.

18. The method of claim 14 or 15, wherein the device further comprises a jaw cover.

19. The method of claim 14 or 15, wherein the container is a vial, bottle, or prescription medicine container.

20. The method of claim 14 or 15, wherein the platform is bent to facilitate attachment to a support structure.

21. The method of claim 14 or 15, wherein the container is opened without touching the container.
